(19) United States
(12) Patent Application Publication
(10) Pub. No.: US 2026/0196403 A1
(43) Pub. Date: Jul. 9, 2026

(54) CONDUCTION WIRE, COIL, AND METHOD FOR MANUFACTURING CONDUCTION WIRE

(71) Applicants: Kabushiki Kaisha Toshiba, Kawasaki-shi (JP); Toshiba Energy Systems & Solutions Corporation, Kawasaki-shi (JP)

(72) Inventors: Kenya Uchida, Yokohama Kanagawa (JP); Kenichi Ooshiro, Yokohama Kanagawa (JP); Kazumitsu Watanabe, Yokohama Kanagawa (JP); Kenji Tasaki, Fuchu Tokyo (JP); Yasuo Kaino, Kawasaki Kanagawa (JP)

(21) Appl. No.: 19/549,370

(22) Filed: Feb. 25, 2026

Related U.S. Application Data
(63) Continuation of application No. PCT/JP2024/026181, filed on Jul. 22, 2024.

(30) Foreign Application Priority Data
Sep. 21, 2023 (JP) 2023-154184

(51) Int. Cl. H01F 27/28; H01F 6/06; H01F 41/04

(52) U.S. Cl. CPC H01F 27/2823; H01F 6/06; H01F 41/048

(57) ABSTRACT

According to one embodiment, provided is a conduction wire including an electrically conductive flat wire, and an insulating film covering the flat wire. Portions of the insulating film covering ends in a width direction of the flat wire are thicker than a portion thereof covering a center in the width direction of the flat wire.

### CROSS-REFERENCE TO RELATED APPLICATIONS

This application is a Continuation Application of PCT Application No. PCT/JP2024/026181, filed Jul. 22, 2024 and based upon and claiming the benefit of priority from prior Japanese Patent Application No. 2023-154184, filed Sep. 21, 2023, the entire contents of all of which are incorporated herein by reference.

### FIELD

The present disclosure relates to a conduction wire, a coil, and a method for manufacturing the conduction wire.

### BACKGROUND

A coil obtained by winding a conductive wire is used, for example, in a drive component of an electric motor. A coil using a superconducting wire is used, for example, as a superconducting coil that generates a strong magnetic field in a nuclear magnetic resonance apparatus (NMR), a magnetic resonance imaging apparatus (MRI), or the like. In such a coil as that described above, an insulating member such as an insulating tape is interposed between wires in order to prevent a short circuit between turns of the wound coil, but a short circuit between turns may occur due to winding deviation or interlayer pressure of the wires and the insulating member.

### BRIEF DESCRIPTION OF THE DRAWINGS

FIG. 1 is a perspective view schematically illustrating an example of a coil.

FIG. 2 is a schematic cross-sectional view illustrating an example of section A in FIG. 1.

FIG. 3 is a schematic cross-sectional view illustrating another example of section A in FIG. 1.

FIG. 4 is a schematic cross-sectional view illustrating an example of a conduction wire according to an embodiment.

FIG. 5 is a schematic cross-sectional view illustrating another example of the conduction wire according to the embodiment.

FIG. 6 is a schematic cross-sectional view illustrating still another example of the conduction wire according to the embodiment.

FIG. 7 is an enlarged cross-sectional view illustrating section B in FIG. 4.

FIG. 8 is a schematic view illustrating an example of manufacture of the conduction wire according to the embodiment.

### DETAILED DESCRIPTION

According to one embodiment, provided is a conduction wire including an electrically conductive flat wire, and an insulating film covering the flat wire. Portions of the insulating film covering ends in a width direction of the flat wire are thicker than a portion thereof covering a center in the width direction of the flat wire.

According to another embodiment, provided is a conduction wire including a flat wire and an insulating film covering the flat wire. The insulating film includes resin beads, and vacancies are provided inside the insulating film.

According to yet another embodiment, provided is a coil including a wound wire and a resin provided on the wound wire. The wound wire includes the conductive wire according to the above embodiments. A part of the resin is impregnated into the insulating film.

According to still another embodiment, provided is a method for manufacturing a conduction wire, including forming an insulating film on a flat wire. The insulating film is formed by depositing a charged raw material solution onto the flat wire. The formed insulating film is thicker at ends than at a center in a width direction of the flat wire.

According to the above configurations, a conduction wire capable of suppressing a short circuit in a coil and having high durability, a coil including the conduction wire, and a method for manufacturing the conduction wire are provided.

Known as a means for reducing defects such as a short circuit of a conduction wire in a coil and improving reliability, is formation of an insulating film on a surface of the conduction wire. On one hand, for example, a thin insulating film is desirable from the viewpoint of increasing a density of the coil for the purpose of avoiding an increase in size thereof, or the like. On the other hand, durability performance including deterioration resistance performance and peeling resistance performance of the insulating film, which leads to prevention of deterioration of the conduction wire, is also desired. In addition, high thermal conductivity is preferable. Of course, a low-cost insulating film forming technique is preferable.

A conduction wire according to an embodiment includes an electrically conductive flat wire and an insulating film covering the flat wire. That is, the conduction wire is a conduction wire with an insulating film. According to one aspect, in the conduction wire, portions of the insulating film covering ends in a width direction of the flat wire are thicker than a portion thereof covering a center in the width direction of the flat wire. According to another aspect, the insulating film of the conduction wire contains resin beads. The conduction wire has vacancies provided inside the insulating film. The conduction wire may simultaneously have features of both the aspects. That is, in the conduction wire, the insulating film containing the resin beads and having the vacancies may cover the ends more thickly than the center in the width direction of the flat wire.

According to the former aspect, since thicknesses of ends of the insulating film are greater than a thickness of a center thereof, high density of the coil can be realized by making the insulating film as a whole be thin, and, at the same time, reliability for preventing a short circuit is improved by increasing the film thicknesses at the ends. An average film thickness of the insulating film is preferably 10 μm or less. More preferably, the film thickness of the insulating film is 10 μm or less at any portion. Thus, with the conduction wire including the thin insulating film, the density of the coil can be made high. Of the insulating film, thicknesses of the portions covering the ends of the flat wire are preferably more than 1 time and 2 times or less a thickness of the portion covering the center of the flat wire. By having the relationship between the thicknesses of the insulating film be of such a ratio, improvement in prevention of a short circuit can be effectively attained while sustaining the thickness of the end portion within such an extent that a high-density coil can be configured.

According to the latter aspect, the insulating film having vacancies is formed of the resin beads. When constructing a coil, a resin is commonly impregnated into a wound wire configured of a wound conduction wire, in order to form a heat transfer path for a conduction wire of each turn and to improve mechanical strength of the coil. In the coil using the conduction wire, the resin enters vacancies of the insulating film so that they are integrated, whereby vibration resistance and thermal conductivity of the coil are improved.

The flat wire included in the conduction wire, and thus the conduction wire, too, may be a superconductor wire. Furthermore, the flat wire and the conduction wire may be high-temperature superconductor wires having a critical temperature of 25 K (Kelvin) or higher, which exhibit superconductivity even at 25 K or higher. A coil using a conduction wire which is a superconductor wire may be a superconducting coil.

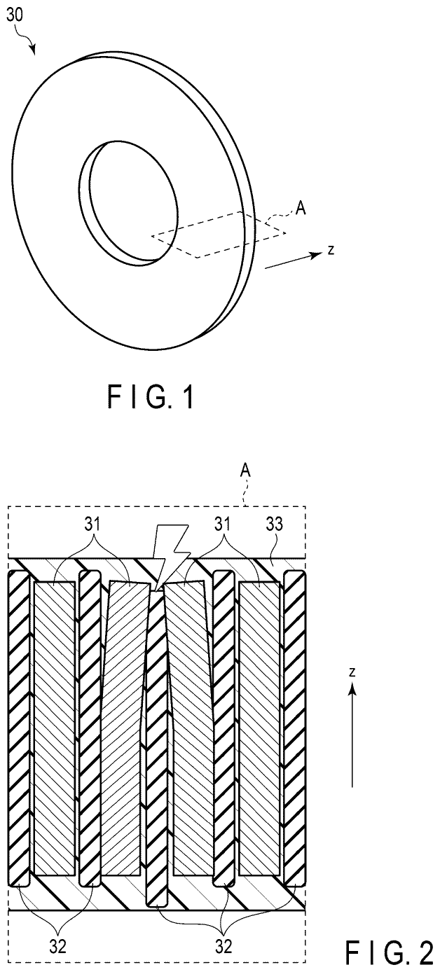

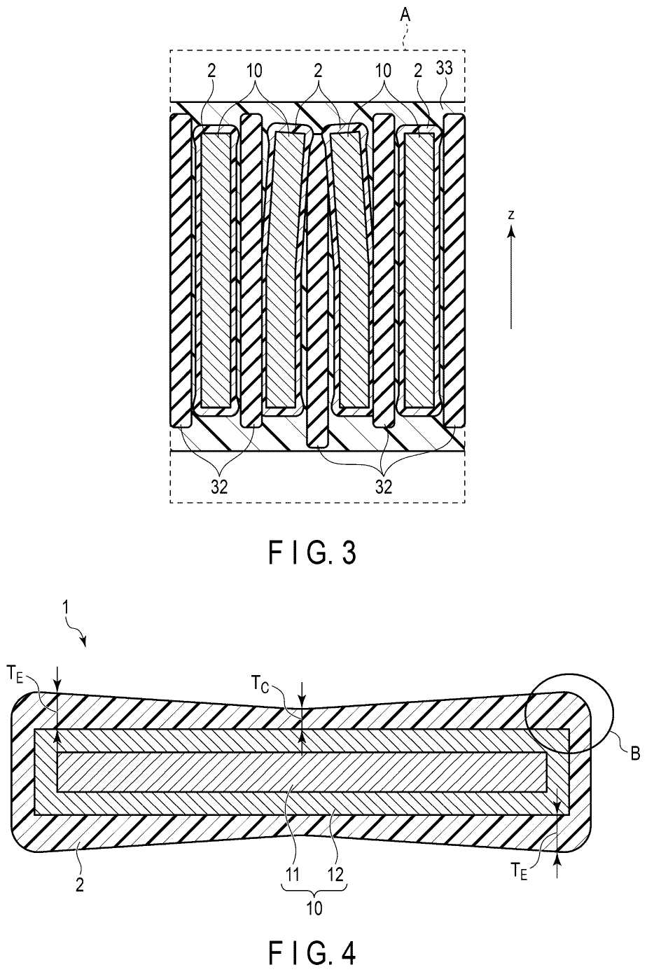

Examples of coils are illustrated in FIGS. 1 to 3. FIGS. 2 and 3 are schematic cross sections obtained by enlarging section A in FIG. 1, and each of FIGS. 2 and 3 illustrates an example of a different coil. FIG. 2 is an enlarged cross-sectional view of section A in a case where a coil 30 illustrated in FIG. 1 is an example of a conventional coil. FIG. 3 is an enlarged cross-sectional view of the section A in a case where the coil 30 illustrated in FIG. 1 is an example of a coil according to the embodiment.

The conventional coil 30 includes a wire 31, an insulating tape 32, and a resin 33 (FIG. 2). Specifically, a periphery of a wound body, in which the wire 31 and the insulating tape 32 are overlapped and wound, and the layers of the wire 31 and the insulating tape 32 stacked by winding are fixed by the resin 33. The coil 30 may have a pancake coil shape, as in the illustrated example. Although not illustrated, the coil 30 may further include a winding frame, around which the wire 31 and the insulating tape 32 are wound. Ideally, the insulating tape 32 is arranged between adjacent turns of the wire 31, and gaps between layers is impregnated with the resin 33, so that a short circuit due to contact between the wires 31 is prevented. However, when the wire 31 and the insulating tape 32 are wound, winding deviation may occur or interlayer pressure may arise, and, as a result, for example, ends in a width direction of the wire 31 may come into contact with each other. Since the wire 31 included in the conventional coil 30 is not covered with an insulating material, a short circuit between turns may occur.

The coil 30 in the case of an example of the coil according to the embodiment includes, as a wire, a conduction wire including a flat wire 10 and an insulating film 2 covering the flat wire 10 (FIG. 3), instead of the uncovered wire 31. Therefore, the resin 33 is provided on the wound wire including the conduction wire according to the embodiment, and a part of the resin is impregnated into the insulating film 2. Except for these points, the coil has the same structure as the example of the conventional coil. Since the conduction wire formed by covering the flat wire 10 with the insulating film 2 is used as a wire, a short circuit between turns does not occur in the coil 30 even if the wires come into contact with each other due to winding deviation or interlayer pressure. In addition, since the resin 33 is partially intruded into the insulating film 2, the conduction wire exhibits high durability.

Note that the above-described width direction of the wire 31 and the width direction of the conduction wire including the flat wire 10 and the insulating film 2 refer to a direction along the thickness direction of the pancake coil shape of the coil 30 denoted as z direction in FIGS. 1 to 3.

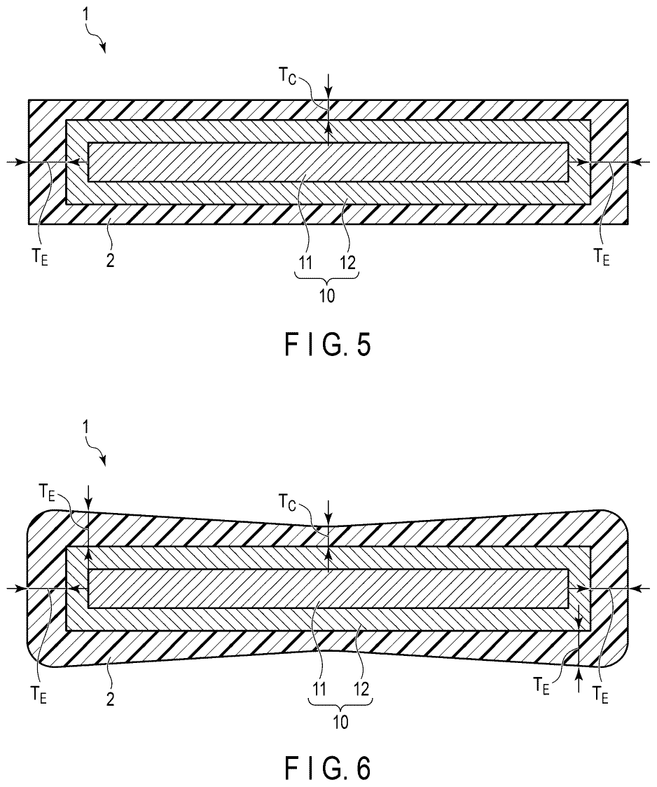

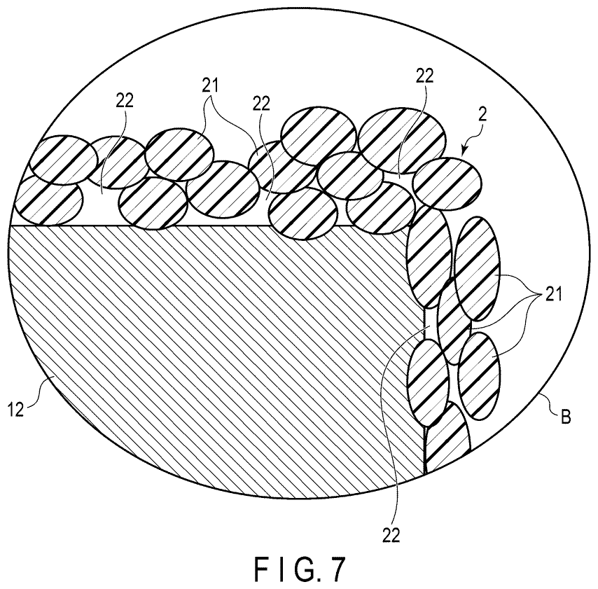

Next, the conduction wire according to the embodiment will be more specifically described with reference to FIGS. 4 to 7. FIG. 4 is a schematic cross-sectional view illustrating an example of the conduction wire. FIGS. 5 and 6 are each a schematic cross-sectional view illustrating another example of the conduction wire. FIGS. 4 to 6 illustrate cross sections intersecting a longitudinal direction of the conduction wire. FIG. 7 is an enlarged cross-sectional view of section B indicated in FIG. 4. Although enlarged cross-sectional views are omitted for FIGS. 5 and 6, structures similar to that in FIG. 7 with respect to FIG. 4 are provided.

The conduction wire 1 includes the flat wire 10 and the insulating film 2 covering an outer periphery thereof. The flat wire 10 may include, for example, a substrate 11 and a stabilizing layer 12 provided on the substrate 11. Although not illustrated, the substrate 11 includes, for example, a metal substrate and a superconducting layer provided thereon. That is, the conduction wire 1 may be a superconductor wire. A coil using such a conduction wire 1 may be a superconducting coil.

For example, a belt-shaped superconducting layer may be provided on one surface of the belt-shaped substrate 11, or a belt-shaped superconducting layer may be provided on each of both surfaces of the belt-shaped substrate 11. Note that the metal substrate typically has a thickness on the order of several tens of microns, and the superconducting layer is typically a thin film having a thickness on the order of several microns. The substrate 11 may further include an intermediate layer provided between the metal substrate and the superconducting layer. The intermediate layer is, for example, a thin film of magnesium oxide (MgO) or the like having a thickness on the order of 1/10 microns, and is sometimes referred to as a buffer layer. The substrate 11 may further include a protective layer made of, for example, silver. The protective layer is provided, for example, on the superconducting layer. In addition, in the substrate 11 in which the superconducting layer is provided only on one surface of the metal substrate, the protective layer may be provided not only on the superconducting layer but also on a surface of the metal substrate on the reverse surface side onto which the superconducting layer is not provided. The protective layer typically has a thickness on the order of a few microns.

The stabilizing layer 12 is formed of, for example, copper, and typically has a thickness on the order of several microns to several tens of microns. The stabilizing layer 12 may be omitted.

The insulating film 2 covers the outer periphery of the flat wire 10. The thickness of the insulating film 2 is greater at both ends than at the central portion along the width direction of the flat wire 10, which is the horizontal direction of FIGS. 4 to 6. The thickness of the insulating film 2 herein refers to a thickness in the thickness direction of the flat wire 10, for example, a thickness along the vertical direction of each figure. The thickness of the insulating film 2 at each end may refer to a thickness along the width direction of the flat wire 10, for example, along the horizontal direction of each figure.

In the example illustrated in FIG. 4, the thicknesses in the thickness direction of the insulating film 2 on the principal surfaces of the flat wire 10 at both ends are thicker than the thickness (thickness in the thickness direction) of the insulating film 2 at the central portion. In the example illustrated in FIG. 5, the thicknesses in the width direction of the insulating film 2 on a lateral surface (end surface) of the flat wire 10 at both ends are thicker than the thickness (thickness in the thickness direction) of the insulating film 2 at the central portion. In the example illustrated in FIG. 6, the thicknesses of the insulating film 2 covering both ends of the flat wire 10 in both the thickness direction and the width direction are thicker than the thickness (thickness in the thickness direction) of the insulating film 2 at the central portion.

With respect to the thickness in the thickness direction, the thickness of the insulating film at each portion on one principal surface side may be different from the thickness of the insulating film at each corresponding portion on the other principal surface side. In addition, satisfaction of the relationship where the thickness of the portion among the insulating film 2 located at each of both ends is greater than the thickness of the portion located at the center in the width direction of the flat wire 10 would be sufficiently be met, by satisfying the relationship per surface of the conduction wire 1. For example, the portion of the insulating film 2 covering the center of one surface of the flat wire 10 may be thicker than the portion covering one or both ends on the other surface (reverse surface) of the flat wire 10. Moreover, among the insulating film 2 on the same surface side, the thicknesses of the portions of each end may be different from one another.

In a similar manner with respect to the thicknesses in the width direction at both ends, the thickness of the insulating film covering the lateral surface of the flat wire 10 at one end and the thickness of the insulating film covering the lateral surface thereof at the other end may be different from each other. Satisfaction of the relationship where the thicknesses of the portions at both ends are greater than the thickness of the central portion of the insulating film 2 would be met, by satisfying the relationship per lateral surface (end surface) in the width direction of the flat wire 10.

The insulating film 2 contains resin beads 21, and is desirably an assembly of the resin beads 21. Vacancies 22 are formed between the resin beads 21 which are linked together to form the insulating film 2. The vacancies 22 are desirably continuous pores rather than isolated spaces. When the vacancies 22 are continuous, the vacancies 22 are easily impregnated with the resin when the coil is constructed, and a coil with the resin intruded into the interior of the insulating film 2 can be obtained.

In addition to the resin beads 21, the insulating film 2 may also contain an organic fiber (for example, a fiber made of a resin). A ratio between the resin beads of the resin material contained in the insulating film 2 and the organic fiber may be set by choice, but the resin beads 21 desirably make up 50 vol % or more. That is, the insulating film 2 preferably contains the resin beads 21 as a main constituent. While a film whose main constituent is an organic fiber includes many through-holes, the vacancies 22 can be formed in the insulating film 2 whose main constituent is the resin bead 21.

The resin beads 21 are desirably fine particles. Specifically, one side of a circumscribed quadrangle of the resin bead is desirably 10 μm or less. The insulating film 2 formed of the resin beads 21 in the form of fine particles can be made thin while including the vacancies 22.

The insulating film 2 may be observed, for example, as follows. The conduction wire to be observed is embedded in a resin and polished to expose a cross section crossing the longitudinal direction of the conduction wire and lying along the width direction and the thickness direction. The cross section of the obtained sample is observed with an optical microscope.

The observed cross section may be similar to the examples illustrated in FIGS. 4 to 6, for example. On each of the obverse and reverse surfaces (both upper and the lower surfaces in FIGS. 4 to 6) of the flat wire 10, the thicknesses of the insulating film 2 covering both ends and the center along the width direction (the horizontal direction in FIGS. 4 to 6) of the flat wire 10 are measured. Here, the flat wire 10 is divided into 15 equal parts in the width direction, and a central sector is defined as the center of the flat wire 10. A thickness T_{C} of the insulating film 2 on the center is measured. Of the 15 sectors, those on each of both ends are defined as ends of the flat wire 10. Thicknesses T_{E} of the insulating film 2 on the ends are measured. In FIG. 4, only the thickness T_{C} at the center upper side and the thicknesses T_{E} at the left upper surface and the right lower surface are illustrated, but the thicknesses at a total of eight points including the thickness (T_{C}) at the center lower side, the thicknesses (T_{E}) at the left lower surface and the right upper surface, and the thickness at the end lateral surfaces (for example, corresponding to the thickness T_{E} illustrated in FIG. 5) which are not illustrated, are measured. In FIGS. 5 and 6, as well, illustration of some of the thicknesses are abridged.

The metal substrate of the flat wire included in the conduction wire may have, for example, a belt shape, more specifically, a flat wire shape. The metal substrate is formed of, for example, a metal material of high strength, such as a nickel-based alloy, stainless steel, or copper.

The superconducting layer of the flat wire is made of a superconducting material, and includes, for example, a Nb—Ti alloy, a niobium compound such as Nb₃Sn, magnesium diboride (MgB₂), an iron-based superconductor, a bismuth-based oxide superconductor, and a rare earth-based oxide superconductor. At least one among the group consisting of yttrium (Y), lanthanum (La), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu) may be included as the rare earth element.

Examples of the resin that is on the wound wire including the conduction wire in the coil and that is partially impregnated into the insulating film may include a thermosetting resin such as an epoxy resin and a thermoplastic resin.

The conduction wire may further include a release layer on top of the insulating film. By providing the release layer, it is possible to weaken binding between the conduction wire and the resin for fixing the wound wire within the coil. For example, the superconducting coil is cooled to a critical temperature or lower during operation in order to exhibit superconductivity. A peeling stress is applied to the conduction wire by thermal stress generated by cooling or electromagnetic stress generated by excitation. With a conduction wire having weakened bonding with the resin due to the release layer, the conduction wire can be peeled off from the resin when peeling stress is applied, and thus, the peeling stress applied to the conduction wire is reduced. As a result, the deterioration of the conduction wire and the performance deterioration of the coil can be suppressed. The release layer is formed of, for example, at least one selected from a fluororesin such as Teflon (registered trademark), paraffin, grease, and silicon oil.

A method for manufacturing the conduction wire according to the embodiment includes depositing a charged raw material solution onto the flat wire, to form an insulating film on a flat wire, where the insulating film is thicker at ends than at a center in a width direction of the flat wire. That is, the conduction wire can be manufactured by electrostatic application. By adopting electrostatic application, an insulating film having thicker portions at the ends can be formed. In addition, by adopting electrostatic application, it is also possible to obtain an insulating film having vacancies, unlike a dense film formed by an electrodeposition method. Moreover, by adopting electrostatic application, a manufacturing cost can be reduced as compared with that when the electrodeposition method is adopted.

In forming the insulating film by electrostatic application, manufacturing conditions under which a raw material solution is deposited onto the flat wire as droplets are desirably used. The deposited droplets become resin beads when dried, and an assembly film of the resin beads can be obtained. A concentration and a viscosity of the raw material solution and a molecular weight of an organic material contained in the raw material solution are preferably appropriately controlled so as to achieve the conditions under which the raw material solution is deposited as droplets on the flat wire. A low-concentration raw material solution tends to more easily form droplets and be deposited on the flat wire as the resin beads. Conversely, a high-concentration raw material solution tends to be deposited as fibers to form a fiber film. A low-viscosity raw material solution tends to more easily form droplets and be deposited as the resin beads, and a high-viscosity raw material solution tends to form a fiber film. A solution containing a raw material having a low molecular weight tends to more easily form droplets and be deposited as the resin beads. Conversely, a solution containing a raw material having a high molecular weight tends to more easily form a fiber film. A low pressure inside the piping tends to more easily form droplets and deposit the resin beads, and a high pressure inside the piping tends to more easily form a fiber film.

After the insulating film is formed, pressing treatment is not performed. When the wire is pressed, an internal structure forming the wire is broken, so that properties may be impaired.

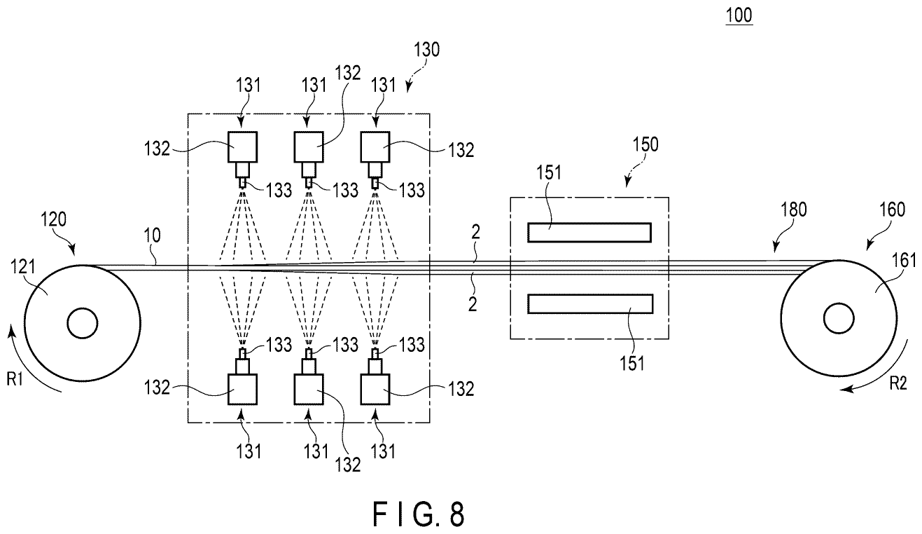

FIG. 8 illustrates an example of manufacture of the conduction wire. FIG. 8 is a schematic view illustrating an example of a conduction wire manufacturing apparatus. As illustrated, a manufacturing apparatus 100 includes an unwinding machine 120, an application mechanism 130, a dryer 150, and a winding machine 160. In addition, a conveyance line 180 is formed in the manufacturing apparatus 100. In the manufacturing apparatus 100, the flat wire 10 is conveyed from the unwinding machine 120 to the winding machine 160 sequentially through the application mechanism 130 and the dryer 150, by the conveyance line 180.

The unwinding machine 120 includes a reel 121. The flat wire 10 is wound around the reel 121 in a roll. In the unwinding machine 120, the reel 121 is rotated in a direction indicated with an arrow R1 by driving a driving member (not illustrated) such as an electric motor. Thereby, the flat wire 10 wound around the reel 121 is unwound. Then, the unwound flat wire 10 is delivered to the conveyance line 180.

The winding machine 160 includes a reel 161. In the winding machine 160, the reel 161 is rotated in a direction of an arrow R2 by driving a driving member (not illustrated) such as an electric motor. Thus, the flat wire 10 conveyed by the conveyance line 180 is wound into a roll by the reel 161.

In the manufacturing apparatus 100, by rotating the reel 121 in the direction indicated with the arrow R1 and simultaneously rotating the reel 161 in the direction indicated with the arrow R2, the flat wire 10 is conveyed from the unwinding machine 120 to the winding machine 160 through the conveyance line 180. Note that one or more guide rollers (not illustrated) that guide the flat wire 10 from the unwinding machine 120 to the winding machine 160 may be provided on the conveyance line 180. In this case, on the conveyance line 180, the guide roller(s) is disposed at least at any one of: between the unwinding machine 120 and the application mechanism 130, between the application mechanism 130 and the dryer 150, and between the dryer 150 and the winding machine 160. The guide roller(s) may also be disposed in either the application mechanism 130 or the dryer 150.

Further, layout of the conveyance line 180 from the unwinding machine 120 to the winding machine 160 is not particularly limited. In one example, the conveyance line 180 extends along a horizontal direction, and, in another example, extends along a vertical direction. In addition, one or more bend portions, fold-back portions, or the like of the conveyance line 180 may be provided between the unwinding machine 120 and the winding machine 160, and the extending direction of the conveyance line 180 may be changed at the bend portions, fold-back portions, or the like. In one example, a fold-back portion of the conveyance line 180 is provided between the application mechanism 130 and the dryer 150, and, in another example, a fold-back portion of the conveyance line 180 is provided in either the application mechanism 130 or the dryer 150.

The application mechanism 130 includes one or more nozzle heads 131, and includes six nozzle heads 131 in the example in FIG. 8. Each of the nozzle heads 131 includes a head body 132 and a nozzle 133 protruding from the head body 132. Each of the nozzle heads 131 may be provided with only one nozzle 133 or a plurality of nozzles 133. In each of the nozzle heads 131, a raw material solution in which an organic material is dissolved in a solvent can be stored inside the head body 132.

In the application mechanism 130, the flat wire 10 unwound from the reel 121 is conveyed toward the winding machine 160. In addition, the application mechanism 130 is provided with a power supply (not illustrated), and a voltage can be applied between the unwound flat wire 10 and each nozzle 133 of the nozzle head 131 by the power supply. In a state where the raw material solution is stored inside the head body 132 of each of the nozzle heads 131, the raw material solution in the nozzle head 131 is charged by applying a voltage between the flat wire 10 and the nozzle head 131. The charged raw material solution is ejected from the nozzle 133 toward the surface of the flat wire 10 unwound by the unwinding machine 120. The ejected raw material solution is deposited to form the insulating film 2 on the surface of the flat wire 10. Therefore, the application mechanism 130 forms the insulating film 2 by electrostatic application.

As the organic material used in the raw material solution, for example, any one or more of polyolefin, polyether, polyimide, polyketone, polysulfone, cellulose, polyvinyl alcohol (PVA), polyamide, polyamideimide, and polyvinylidene fluoride (PVdF) are selected. Examples of the polyolefin include polypropylene (PP) and polyethylene (PE). The organic material contained in the raw material solution serves as a raw material for the insulating film and the resin bead forming the insulating film.

In each of the nozzle heads 131, the organic material is dissolved in the solvent. As the solvent that dissolves the organic material in the raw material solution, dimethylacetamide (DMAc), dimethylsulfoxide (DMSO), N, N-dimethylformamide (DMF), N-methylpyrrolidone (NMP), acetone, dimethoxyethylene, toluene, tetrahydrofuran, water, and alkanes, ketones, esters, alcohols, ethers, and the like are used. For an organic material having low solubility, a sheet of organic material may be dissolved by a laser or the like. Further, in the raw material solution, a plurality of species of solvents may be mixed and used. Here, one or more of the solvents used in the raw material solution are preferably organic solvents having a boiling point of 100° C. or higher. Examples of the organic solvent having a boiling point of 100° C. or higher include dimethylacetamide, dimethylsulfoxide, N, N-dimethylformamide, N-methylpyrrolidone, and toluene.

The voltage between the nozzle 133 of each of the nozzle heads 131 and the flat wire 10 is appropriately determined according to the species of the solvent and solute in the raw material solution, the boiling point and vapor pressure curve of the solvent of the raw material solution, the concentration and temperature of the raw material solution, a shape of the nozzle 133, a distance between the flat wire 10 and the nozzle 133, and the like. As described above, the shape of the raw material solution discharged from the nozzle 133 changes according to the concentration and the viscosity of the raw material solution, the molecular weight of the organic material contained in the raw material solution, and the pressure in the piping when supplying the raw material solution to the nozzle head 131.

In the example in FIG. 8, in the application mechanism 130 between the unwinding machine 120 and the winding machine 160, the insulating film 2 is formed on the surface of the flat wire 10 as described above. Therefore, in the winding machine 160, the conduction wire with the insulating film 2 is wound around the reel 161.

The dryer 150 is disposed between the application mechanism 130 and the winding machine 160 on the conveyance line 180. Further, the flat wire 10 having the insulating film 2 formed on the surface thereof is conveyed from the application mechanism 130 to the dryer 150. The dryer 150 dries the insulating film 2 formed on the surface of the flat wire 10 before the conduction wire with the insulating film 2 is wound around the reel 161 of the winding machine 160.

In the illustrated example, the dryer 150 includes an infrared heater 151. The infrared heater 151 generates infrared rays. The infrared heater 151 emits generated infrared rays to the insulating film 2 formed on the surface of the flat wire 10. Functional groups contained in the organic material, the solvent, and the like in the insulating film 2 absorb the infrared rays emitted from the infrared heater 151, so that the insulating film 2 is heated and the solvent contained in the insulating film 2 is evaporated. As a result, an amount of the solvent contained in the insulating film 2 is reduced, and the insulating film 2 is dried.

Drying of the insulating film 2 in the dryer 150 is not limited to drying using the infrared rays emitted from the infrared heater 151. In one example, in the dryer 150, the insulating film 2 may be dried using hot air instead of the infrared rays emitted from the infrared heater 151.

### EXAMPLES

Examples will be described below, but none of the embodiments is limited to the following examples.

A conduction wire with an insulating film was prepared as follows. A flat wire-shaped superconducting wire, in which an oxide-based high-temperature superconducting material layer was provided on a metal substrate and an outer periphery thereof was covered with copper, was prepared. Insulating resin beads were deposited onto the superconducting wire by electrostatic application to form an insulating film.

A raw material solution for a resin film that forms the insulating film was prepared by dissolving polyamideimide in dimethylacetamide. The raw material solution was prepared so that a solid content concentration of the raw material solution was 22 mass %. A polyamideimide having a low molecular weight was used.

The conduction wire with the insulating film was prepared as described above.

Cross sections of the obtained conduction wire with the insulating film were observed by the above-described method. Two cross sections in the width direction of the conduction wire were obtained along the longitudinal direction. In both cross sections, formation of the insulating film on the entire periphery including the ends in the width direction of the conduction wire was confirmed. As shown in Table 1, in both cross sections, the thicknesses of the insulating films formed on both upper and lower surfaces of the flat wire (superconducting wire) were greater at the ends than at the center. In addition, the thicknesses of the insulating films on lateral surfaces of the flat wire (end surfaces in the width direction) were greater on the lateral surfaces than on the upper and lower surfaces.

TABLE 1

| | Thickness | | Thickness |
|---|---|---|---|
| | of | Thickness | of |
| | insulating | of | insulating |
| | film on | insulating | film on |
| | one | film in | other |
| | end side | center | end side |
| Cross section 1 | 4.8 μm | 3.9 μm | 4.2 μm |
| upper surface side | | | |
| Cross section 1 | 5.4 μm | 4.4 μm | 5.3 μm |
| lower surface side | | | |
| Cross section 1 | 8.7 μm | — | 8.0 μm |
| lateral surface side | | | |
| Cross section 2 | 6.4 μm | 5.1 μm | 5.5 μm |
| upper surface side | | | |
| Cross section 2 | 6.6 μm | 4.1 μm | 4.6 μm |
| lower surface side | | | |
| Cross section 2 | 10.7 μm | — | 8.7 μm |
| lateral surface side | | | |

The obtained conduction wire with the insulating film was evaluated with respect to five items. The results are summarized in Table 2 below. As shown in Table 2, the obtained conduction wire with the insulating film showed good results for each evaluated item.

Specifics follow.

A sample of the conduction wire with the insulating film was immersed in a resin liquid and ethanol, and the presence or absence of elution of the resin forming the insulating film was examined. As shown in Table 2, elution was not confirmed.

In order to examine the mechanical strength of the insulating film, the sample was conveyed by a roll-to-roll method, and whether scraping, peeling off of the insulating film from the flat wire, or the like had occurred was examined. As shown in Table 2, the insulating film was not peeled off.

A heat cycle strength of the insulating film was evaluated as follows. A heat cycle test was performed in which the sample was alternately exposed to a cryogenic temperature environment at 77 K and a room temperature environment. As shown in Table 2, no cracking or peeling of the insulating film was observed in the sample after the heat cycle test.

The insulation performance of the insulating film was evaluated. Specifically, a contact electric resistance value was measured at room temperature and 77 K, respectively. As shown in Table 2, the sample exhibited an electrical resistance of 1Ω or more at either measurement temperature.

In order to evaluate the superconductive character of the conduction wire with the insulating film, a critical current value (Ic) was measured at 77 K before and after formation of the insulating film. As shown in Table 2, no decrease in critical current value associated with film formation was confirmed. In addition, since superconductivity had exhibited at 77 K, the obtained conduction wire with the insulating film can be considered a high-temperature superconductor wire having a critical temperature of 25 K or more.

TABLE 2

| Evaluation item | Result |
|---|---|
| Chemical resistance of film | No elution into |
| | resin or ethanol |
| Mechanical strength of film | No peeling-off |
| Heat cycle strength between | No cracking or peeling |
| cryogenic temperature (77 K) | |
| and room temperature | |
| Contact electric resistance | 1 Ω or more at |
| value (room temperature · 77 K) | either temperature |
| Evaluation of | No decrease in |
| superconductive character | critical current (Ic) |

According to at least one embodiment and example described above, a conduction wire is provided. The conduction wire includes an electrically conductive flat wire and an insulating film covering the flat wire. Among the insulating film, portions covering ends in a width direction of the flat wire is thicker than a portion covering the center. Alternatively, the insulating film includes resin beads, and includes vacancies inside. The conductive wire has high durability, and can provide a coil with suppressed short circuits.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Several of the presently disclosed embodiments are listed below.
1. A conduction wire comprising:
an electrically conductive flat wire; and
an insulating film covering the flat wire,
portions of the insulating film that cover ends in a width direction of the flat wire being thicker than a portion thereof covering a center in the width direction of the flat wire.
2. The conduction wire according to clause 1, wherein an average film thickness of the insulating film is 10 μm or less, and thicknesses of the portions of the insulating film covering the ends are more than 1 time and 2 times or less a thickness of the portion thereof covering the center.
3. A conduction wire comprising:
a flat wire; and
an insulating film covering the flat wire,
the insulating film comprising resin beads, and vacancies being provided inside the insulating film.
4. The conduction wire according to clause 3, wherein one side of a circumscribed quadrangle of the resin beads is 10 μm or less.
5. The conduction wire according to any one of clauses 1 to 4, wherein the flat wire is a superconductor wire.
6. The conduction wire according to any one of clauses 1 to 5, further comprising a release layer on the insulating film.
7. A coil comprising:
a wound wire comprising the conduction wire according to any one of clauses 1 to 6; and
a resin provided on the wound wire, a part of which is impregnated into the insulating film.
8. A method for manufacturing a conduction wire, comprising: depositing a charged raw material solution onto a flat wire to form an insulating film on the flat wire, the insulating film being thicker at ends than at a center in a width direction of the flat wire.

What is claimed is:

1. A conduction wire comprising:
an electrically conductive flat wire; and
an insulating film covering the flat wire,
portions of the insulating film that cover ends in a width direction of the flat wire being thicker than a portion thereof covering a center in the width direction of the flat wire.

2. The conduction wire according to claim 1, wherein an average film thickness of the insulating film is 10 μm or less, and thicknesses of the portions of the insulating film covering the ends are more than 1 time and 2 times or less a thickness of the portion thereof covering the center.

3. A conduction wire comprising:
a flat wire; and
an insulating film covering the flat wire,
the insulating film comprising resin beads, and vacancies being provided inside the insulating film.

4. The conduction wire according to claim 3, wherein one side of a circumscribed quadrangle of the resin beads is 10 μm or less.

5. The conduction wire according to claim 1, wherein the flat wire is a superconductor wire.

6. The conduction wire according to claim 1, further comprising a release layer on the insulating film.

7. The conduction wire according to claim 5, further comprising a release layer on the insulating film.

8. A coil comprising:
a wound wire comprising the conduction wire according to claim 1; and
a resin provided on the wound wire, a part of which is impregnated into the insulating film.

9. A method for manufacturing a conduction wire, comprising: depositing a charged raw material solution onto a flat wire to form an insulating film on the flat wire, the insulating film being thicker at ends than at a center in a width direction of the flat wire.
